(19) United States
(12) Patent Application Publication
(10) Pub. No.: US 2010/0310129 A1
(43) Pub. Date: Dec. 9, 2010

(54) IMAGE ANALYSIS METHOD, IMAGE ANALYSIS SYSTEM AND USES THEREOF

(75) Inventor: Sebastian Höpfner, Munchen (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Max-Planck-Gesellschaft zur Forderung der Wissenschaften e.V., Munchen (DE)

(21) Appl. No.: 12/746,283

(22) PCT Filed: Dec. 5, 2008
(86) PCT No.: PCT/EP2008/010379

§ 371 Date: Aug. 13, 2010

(30) Foreign Application Priority Data
Dec. 5, 2007 (EP) PCT/EP2007/010557

(51) Int. Cl. G06K 9/36

(52) U.S. Cl. 382/104; 382/276; 382/128

(57) ABSTRACT

The present invention relates to an image analysis method for analyzing a digital image comprising transforming object-pixels into a vector dataset. The vector for each object pixel comprises a positional, a directional and a distance component. The number of vectors in the dataset is reduced based on neighborhood criteria. The remaining vectors can code the object by means of a centerline and pointers to its contour.

The present invention relates to an image analysis method for analyzing a digital image comprising transforming at least one object-pixel into a vector dataset. The method is useful to determine the shape and medial axis of an object depicted in an image. The invention also provides a computer program product stored on a computer readable storage medium, an apparatus for carrying out the image analysis method, a data processing system capable of carrying out the image analysis method according to the invention, an image analysis system and a system for controlling a vehicle travelling on a road. Also comprised is the use of the image analysis method of the invention in an application selected from the group consisting of medical image analysis, traffic control, vehicle guidance, automated product quality control, semiconductor chip topography quality control, semiconductor chip connector quality control, microscopy image analysis, similarity searches for similar digital images in a database, digital image compression and text recognition.

### BACKGROUND OF THE INVENTION

Although the human eye can readily distinguish between objects in an image, this is generally not the case for computer-implemented machine vision systems. Such systems typically receive and/or collect information from the environment by a sensor such as a digital camera and then transfer such data e.g. in form of digital images, to an image analysis system for analysis. Methods and systems comprised in the art which are implemented to analyze the images of objects are generally limited in their use. In fact, machines using a form of automated vision are typically equipped with a specific image analysis method which is designed and trained to function in a predefined environment. Thus, the faces of people may be recognized in a streaming video, or the precise location of leads in the “lead frame” and pads on the semiconductor die can be recognized to facilitate automated wire bonding of integrated circuits. However, each of these exemplary applications will require its own specifically designed image analysis method. Due to the numerous areas in which image analysis is used in today's industrial setting, there is a need for reliable and especially universally applicable image analysis methods.

A basic problem in image analysis is the classification of objects by their shape. Several image analysis methods for finding objects in an image are comprised in the art. Such methods generally isolate the edges of the objects in an image to extract the shape of the objects. Edge detection can be complicated when false edges are created by noise present in the image. The number of false edges can be lowered by using noise reduction techniques before detecting edges. A typical noise reduction method for, image analysis comprises applying e.g. a median filter to the image as an extra step before commencing with the actual edge detection process. The median filter is suitable for e.g. removing salt and pepper noise from the image, while causing little blurring of the edges. Unfortunately, such extra noise-suppressant steps significantly add to the computational load and result in slower processing speeds.

The edges of an object in an image can be found by e.g. applying a Sobel filter, a Hough transform or a Voronoi diagram. Also the medial axis of an object can be found, for example by generating a medial axis transform. The medial axis of an object is the set of the centers of all the maximal inscribed circles, and when the radius information is also included, the sum of centers with the radius information is called the medial axis transform. The medial axis transform was first studied by Blum, and after him, many authors, including D. T. Lee, R. L. Drysdale and others have studied and suggested various methods of calculating the medial axis transform.

Although the medial axis transform methods comprised in the art provide useful information in pattern recognition problems, the computational effort needed to extract the medial axis transform often makes the utilization of this method unattractive. Furthermore, medial axis transform methods comprised in the art are especially sensitive towards noise in the object and/or noise present in the background of the image. Methods improving the noise sensitivity (e.g. median filter) further add to the computational burden, slowing the image analysis process. In addition to a noise filter, medial axis methods comprised in the art typically require additional time consuming trimming and correction steps to isolate useful medial axis data of an object. In all applications using an image analysis method, it is desirable to reduce the computational load of the analysis to a minimum, thereby reducing the processing time and preferably allowing real-time analysis of the sensor data, for example, of digital images. Additionally, the provision of medial axis transform data per se is insufficient in several areas of use, especially when more complex analysis procedures are required, such as in the field of biomedical image analysis, in automated product quality control and for similarity searches for similar images in a database.

Thus, there is a long felt but unresolved need for providing an improved image analysis method which is time efficient, can be universally applied and which overcomes the above-outlined problems existing in image analysis methods and systems comprised in the art.

### SUMMARY OF THE INVENTION

Therefore, to solve above-mentioned problems, the present invention provides in a first aspect an image analysis method for analyzing a digital image comprising a plurality of object-pixels that define at least one object in said digital image, wherein the image analysis method comprises the step of transforming at least one object-pixel into at least one vector in a vector dataset and wherein the at least one vector comprises a positional component, a directional component and a distance component.

The invention also provides a computer program product stored on a computer readable storage medium comprising a computer-readable program code for causing a computer to carry out the image analysis method of the invention.

Further provided is an apparatus for carrying out the image analysis method according to the invention. Also comprised is a data processing system, e.g. a personal computer, comprising a memory device, an operating system and the computer program product according to the invention which is loaded into the memory device of said data processing system and wherein the data processing system is capable of carrying out the image analysis method according to the invention.

Also comprised is an image analysis system comprising an imaging device and the data processing system of the invention or the apparatus according to the invention; wherein the imaging device is capable of acquiring digital images and wherein the acquired digital images are transferred to said data processing system or said apparatus.

A further aspect of the invention is a system for controlling a vehicle travelling on a road, comprising:
(a) a vehicle; and
(b) an image analysis system according to the invention, wherein the imaging device is a digital camera, a night vision device and/or a radar equipment; and
(c) optionally a computational device which receives at least one vector dataset from the image analysis system and determines the relative position and the relative velocity of detected objects with respect to the position and velocity of the controlled vehicle; and
(d) optionally a controlling device which receives the computed data from the computational device and controls the direction in which the vehicle is driving and the vehicle's velocity such as to prevent the vehicle form leaving the sides of the road and/or to prevent a collision with an object on the road.

Another aspect of the present invention is the use of the image analysis method according to the invention, the data processing system of the invention, the apparatus according to the invention, or the image analysis system according to the invention in an application selected from the group consisting of medical image analysis, traffic control, vehicle guidance, automated product quality control, semiconductor chip topography quality control, semiconductor chip connector quality control, microscopy image analysis, similarity searches for similar digital images in a database, digital image compression and text recognition.

### DETAILED DESCRIPTION OF THE INVENTION

Before the present invention is described in detail below, it is to be understood that this invention is not limited to the particular methodology, protocols and hard- or software-components described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

Preferably, the terms used herein are defined as described in “Hoggar, Stuart G., Mathematics of image analysis: creation, compression, restoration, recognition”; Cambridge University Press, 2005.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Several documents are cited throughout the text of this specification. Each of the documents cited herein (including all patents, patent applications, scientific publications, manufacturer's specifications, books, instructions, etc.), whether supra or infra, are hereby incorporated by reference in their entirety. Nothing herein is to be construed as an admission that the invention is not entitled to antedate such disclosure by virtue of prior invention.

In the following, some definitions of terms frequently used in this specification are provided. These terms will, in each instance of its use, in the remainder of the specification have the respectively defined meaning and preferred meanings.

A digital image is comprised of “pixels”. A pixel (short for picture element, using the common abbreviation “pix” for “picture”) is a single point in a graphic picture such as a digital image. In a digital image, the pixel represents the smallest possible element or sample of this digital image. In any one instance one pixel can only define one intensity value of one picture element within said image. Said intensity value is a numerical value encoding the colour, grey-shade or presence or absence of signal (for example in a black and white only image) of a pixel within a picture which can be, for example, a digital image. In preferred embodiments a pixel may be a voxel. Thus, the method of the invention can also be used to process voxels comprised in a 3-dimensional or more-dimensional (for example a 3D movie) image data set. In general it is known to the skilled artisan how to apply the method of the invention to more dimensional e.g. 3D image data. In a preferred embodiment, a 3D image can be analyzed by subdividing it into a stack of 2D images as is well known in the art. Next, the pixel intensity information of all 2D images of said stack is projected into a plane. Thus, by such projection a digital image is generated that can be analyzed using the method of the invention. To reduce 3D or 4D image information to 2D image information, a maximum intensity projection may be used for example. A maximum intensity projection (MIP) is a method that projects in a pre-defined visualization plane the voxels with maximum intensity that fall in the way of parallel rays traced from the viewpoint to the plane of projection. This technology is also described e.g. in Wallis J W, et. al., three-dimensional display in nuclear medicine, IEEE Trans Med. Imag. 1989; 8:297-303. In one embodiment, the 3D image dataset is projected once onto its X-Z plane and once onto its Y-Z plane and the resulting maximum intensity projection digital images of the X-Z and Y-Z plane are processed using the method of the invention. The resulting vector datasets for each plane (X-Z and YZ) can optionally be combined to generate a 3D vector dataset. As used herein, “noise” consists of noise-pixels. A noise pixel has an intensity value (see below) which deems it to be either an object-pixel or a non-object pixel. However, only the location of a noise pixel with respect to its neighboring pixels defines, if the respective noise pixel is an integral part of an object or if it in fact belongs to the background of the image. Thus, an object-pixel which is a noise pixel has the intensity value of a non-object pixel (background pixel) and a non-object pixel which is a noise pixel has the intensity value of an object-pixel. Examples for noise pixels are shown in FIG. 5B. Thus, noise-pixels which are located within an object belong to this object and are also object-pixels even if their intensity value would assign them to belong to the background of the image. An object pixel which is a noise pixel has the intensity value of a background pixel and contacts at least two, at least three, at least four, preferably at least three object pixels that are not noise pixels. A non-object pixel which is a noise pixel has the intensity value of an object-pixel and contacts at least two, at least three, at least four, preferably at least three non-object pixels that are not noise pixels. Preferred embodiments of the method of the invention which can be used to transform object-pixels in a digital image which comprises noise-pixels are provided below.

As used herein, an “object” in a digital image consists of a plurality of object-pixels which form the shape of a visible object which is depicted in the digital image. Pixels that form the “object” thus have intensity values which lie in a different range of intensity values than all other pixels which do not belong to the object. This is self evident in a black and white only image. In color or grey-shade images, said range is preferably defined by one or more threshold values. For example, characteristic grey shade values or color tone values that are present in the one or more object of interest are determined and a corresponding numerical intensity threshold range is defined for the object(s). All pixels that have numerical values that lie within the determined threshold range will be considered object-pixels and all other pixels will be considered non-object pixels or vice-versa. For example, in a grey shade image, the threshold range may be defined to range from 128 to 255. Thus, in one example, pixels having a numerical value of greater or equal than 128 and smaller or equal to 255 will be object-pixels. Further methods determining such thresholds are described below in more detail.

Thus, an “object” in a digital image consists of “object pixels”. If noise pixels are present in a digital image, an “object” may also comprise noise pixels. If a digital image comprises several visible objects which are spatially separated in the image, then the method of the invention preferably treats all objects as one single object. Thus, preferably, all object-pixels are transformed irrespective to which object they belong. In another preferred embodiment, spatially separated objects are transformed individually, i.e. only object-pixels that belong to one or more selected objects are transformed using the method of the invention.

As used herein “background” is the set of all pixels in the digital image which are not object pixels. If noise pixels are present in a digital image, the “background” may also comprise noise pixels.

As used herein, “medial axis” refers to the medial axis of an object. In the context of the present invention, this medial axis can also be an approximation of the medial axis and/or a part of the medial axis.

A “vector” as used herein is not a free vector but is a vector which is bound to its fixed or initial point which is defined by the “positional component” of the vector. Additionally, the vector is defined by a “directional component” and a “distance component”. Preferably, the directional component of the “vector” as used herein is defined as a numerical value that defines the angle that is formed between the “vector” and a common predefined reference unit vector. Preferably, the digital image is a rectangular image. Preferably, the reference unit vector is defined by a free vector of the length of at least one pixel, which is orthogonal to the East side (edge) of the image and which points from a point within the image to the East. The “distance component” is defined to equal the length of the vector, preferably in pixels units. As already mentioned, the term “positional component” refers to the location of the origin of the vector which is the location of the object-pixel within the digital image that was transformed to generate the vector. A “vector dataset” refers to one or more vectors. In other words, the “vector dataset” is not a separate entity (e.g. data-structure) but merely serves as synonym for the sum of all vectors generated by the method of the invention. Thus, if, for example, in a preferred embodiment of the method according to the invention, at least 15% of all object-pixels are transformed into vectors, these vectors are referred to as “vector dataset”.

As used herein “contact”, “contacts” or “contacting” means that two entities, for example pixels, are directly touching each other. For example: two pixels in a two-dimensional array of pixels “contact” each other, if the distance between the location of both pixels does not exceed 1 pixel. Two vectors “contact” each other if their points of origin, i.e. the pixels defined by their positional components, are in contact with each other. If not all object pixels are analyzed by the method of the invention but only a representative number of object-pixels, e.g. at least 25% of all object pixels are analyzed then two vectors “contact” each other, if for none of the pixels located between the two pixels defined by the positional components of said two vectors any third vector has been determined.

Image analysis methods comprised in the art using a medial axis transform only determine and use the positional information of the medial axis, i.e. the position of the centers of all the maximal inscribed circles and the radius information of these circles. Such positional information, thus, comprises the medial axis which can be represented as a skeleton of the analyzed object (for example, see FIG. 7B). The skeleton together with the radius information preserves many of the topological and size characteristics of the original shape. However, based on the positional information, i.e. the medial axis skeleton and the radius information alone, it is not possible to derive without extensive computational effort a dataset that also describes the location of the points of the edge, i.e. on the boundary of the object which was analyzed. As used herein, the terms “edge” or “boundary” or “surface”, all of which are being used interchangeably herein, of an object comprises the multiplicity of non-object pixels, i.e. the background pixels in an image which directly contact and/or surround the object-pixels of an object in said digital image. In preferred embodiments points on a noise-corrected object surface are determined. In that case the object boundary may extend to non-object or object-pixels pixels neighboring or surrounding the non-object pixels that are in direct contact with the object. This may especially be the case, if step (b) of the method of the invention is used (see below). Noise corrected object surfaces are useful to achieve an improved accuracy of the vector dataset when noise is present in the digital image or when the object boundary exhibits small irregularities which can be cancelled out using the preferred embodiments of the method of the invention, such as step (b) of the method. Thus, a vector P′ as shown in FIG. 5A is deemed to also point to the object boundary as defined herein.

While determining the medial axis information, it is advantageous to also determine the directional information, i.e. information of the boundary of the analyzed object. Thus, as a first aspect the present invention provides an image analysis method for analyzing a digital image comprising a plurality of object-pixels that define at least one object in said digital image, wherein the image analysis method comprises the step of transforming at least one, two, three, four, five, six, seven, eight, nine, or more object-pixels, preferably at least 5%, 10%, 15%, 20%, 25%, 30%, 35%, 40%, 45%, 50%, 55%, 60%, 65%, 70%, 75%, 80%, 85%, 90%, 95% or 100% of the object-pixels that are comprised in the image, or that are comprised in an individual object, into at least one, two, three, four, five, six, seven, eight, nine, or more vectors in a vector dataset and wherein the at least one, two, three, four, five, six, seven, eight, nine, or more vectors comprise a positional component, a directional component and a distance component. In a preferred embodiment of the method, each transformed object-pixel results in one vector. Thus, if, for example, at least 25% of all object-pixels is transformed, then said vector dataset will comprise the same number of vectors as the number of object-pixels that were transformed. Further preferred is an embodiment of the method of the invention, wherein the positional component of each vector is selected such that it defines the location of the respective transformed object-pixel and the distance and directional component of each vector is selected such that the transformed vector is a surface normal vector, i.e. the vector points from the object-pixel to the object-surface and is a surface-normal vector. In a further preferred embodiment of the method, the method comprises the step:
(a) selecting the positional, directional and distance component of each vector such that the vector points from the respective object-pixel to the non-object pixel or to the group of non-object pixels that is located closest to said respective object-pixel;
   Another preferred embodiment of the method of the invention is the image analysis method for analyzing an object depicted in a digital image, wherein the object consists of object-pixels and wherein the image analysis method comprises the step:
(a) determining a vector for at least one object pixel of the object and preferably for at least 20%, 25%, 30%, 35%, 50%, 75%, 99% or 100% of all object pixels, most preferably for all object pixels of the object, wherein each vector comprises a positional component, a directional component and a distance component and wherein said positional, directional and distance component is selected such that the vector points from the respective object-pixel to the non-object pixel or to the group of non-object pixels that is located closest to said respective object-pixel;
   wherein all determined vectors are referred to as a vector dataset.

Thus, the method determines in step (a) vectors that point from said object-pixel to a point on the surface or noise-corrected object surface that is closest to the object-pixel. Thus, the positional component of a vector defines the location of the respective object-pixel. The distance component defines the distance between the respective object-pixel and the non-object pixel or group of non-object pixels that is located closest to said respective object-pixel. Finally, the directional component defines the direction in which the closest non-object pixel or group of non-object pixels (preferably on the object surface or noise-corrected object surface, respectively) is located with respect to the object-pixel for which the vector is determined. As used herein “closest” or “nearest” refers to the shortest geometric distance between two points, e.g. between two pixels, two groups of pixels or between a pixel and a group of pixels. The closest group of non-object pixels preferably consists of two, three, four, five, six, seven, eight, nine, ten or more non-object pixels, preferably two or three non-object pixels which contact each other and which are preferably contacting the selected circle (CC) as further specified below. A vector that points to the closest group of non-object pixels may point to any one non-object pixel in said group of non-object pixels.

The image analysis method of the invention is also referred to herein as “the method of the invention”. Preferably, for each object-pixel that is transformed, one respective vector is generated according to the method of the invention. As used herein, “transforming” means also “determining”. Thus, according to the method of the invention, object-pixels are not only transformed into positional information (e.g. the medial axis skeleton) and distance information (e.g. the radius information) but also into a directional information. Thus, the vector dataset obtainable according to the method of the invention constitutes a versatile shape descriptor which is much more easily handled by subsequent mathematical and statistical analysis methods than the mere sum of object-pixels in the digital image. For example, the coordinates of the endpoints of the vectors (i.e. the pixel that a vector points to) in the vector dataset can be used to determine the circumference and surface area of the analyzed object. Furthermore, the vector in the dataset having the largest distance component equals half of the maximal width of the object(s) (see for example FIG. 8). Additionally, vectors that contact each other can be grouped and, thus, the number of objects depicted in a digital image can be determined by counting said groups. Furthermore, the average positional information of the vectors can be used to define the geometrical center-point of an object and the average directional information can be used to determine the orientation of the object or objects, i.e. in which direction an object is pointing. In general, the average directional components of all vectors of one object will point perpendicular to the direction that said object is pointing towards (see, for example, FIG. 8). As will be further described below in detail, the vector dataset producible by the method of the invention can also be used to efficiently determine the medial axis of the object or objects of the digital image by carrying out a further selection step (c). The total umber of vectors that originate from the medial axis is proportional to the length of the object, which, thus can be quantified.

In a preferred embodiment of the method of the invention, the image analysis method further comprises the step:
(b) adjusting the directional components of the vectors of the vector dataset such that they are surface-normal vectors.
   Thus, vectors generated in step (a) that are pointing to the object surface are preferably adjusted to be surface-normal vectors. In one embodiment, steps (a) and (b) are carried out in that order for each individual object-pixel that is used according to the method of the invention. In another embodiment, step (a) is first carried out for all object-pixels processed according to the method of the invention and then step (b) is carried out subsequently for all vectors determined in step (a) in a separate step. Preferred embodiments of step (b) are described in detail further below.

Preferably, the at least one, two, three, four, five, six, seven, eight, nine or more vectors or at least 5%, 10%, 15%, 20%, 25%, 30%, 35%, 40%, 45%, 50%, 55%, 60%, 65%, 70%, 75%, 80%, 85%, 90%, 95% or 100% of all vectors generated by the method of the invention are surface normal vectors. As used herein, a “surface normal vector” is a vector which (i) points from an object-pixel of an object to the edge or surface of the object and/or which (ii) is orthogonal to a tangent line to that object edge or object surface. As used herein, a “surface normal vector” may also form an angle which deviates +/−10% from a vector which (i) points from an object-pixel of an object to the edge or surface of that object and which (ii) is orthogonal to a tangent line that passes through that object edge or object surface point that the vector points to. Thus, depending if noise is present in the image near or on the object boundary and depending on the shape complexity of the object, the directional component of a surface normal vector as used in the invention may in some cases only approximate the surface normal within the indicated margins. Examples for such normal vectors are depicted as arrows in e.g. FIG. 7C, 8B, 9B or 10B or e.g. in the panels of FIGS. 11 and 12.

In a preferred embodiment, the method of the invention transforms a representative number of object-pixels of an object in a digital image. This representative number of object-pixels can be, for example, 5%, 10%, 20%, 30%, 40%, 50%, 60%, 70%, 80%, 90%, 95%, 98%, 99% or 100% of all object-pixels which are comprised in the digital image or, if one isolated selected object is transformed, of all object-pixels which are comprised in the selected object. In a further embodiment, said “representative number” of object-pixels refers to a number of between 10% and 100%, between 20% and 100%, between 30% and 100%, between 40% and 100%, between 50% and 100%, between 60% and 100%, between 70% and 100%, between 80% and 100%, between 90% and 100% or of 100% of all object-pixels comprised in the digital image. The digital image comprises preferably at least 5000, 16000, 20000, 200000, 1000000, or at least 10000000 pixels. Digital images having a typical size are, for example, analyzed in FIG. 15. It is further preferred that in the digital image at least 1%, 2%, 3%, 4%, 5%, 10%, 20%, 30%, 40%, 50%, 60%, 70%, 80%, 90%, 95% or at least 99% of all pixels of the digital image are object pixels. FIG. 16 shows examples of the numbers of object-pixels comprised in different images.

If vectors are only determined for a fraction of all object pixels, it is preferred that the analyzed object-pixels are equally distributed over the object that is analyzed, e.g. by analyzing only every other object pixel. In cases where not all object-pixels of the digital image are transformed, it is preferred to determine the vectors which correspond to the non-transformed object-pixels by interpolating the positional components, directional components and/or distance components of the vectors of the transformed object-pixels. Several methods of interpolation are known in the art and can be used in the method of the invention, for example, linear interpolation, nearest neighbor interpolation, polynomial interpolation, spline interpolation and methods based on the Gaussian function. In a more preferred embodiment, the method of the invention transforms every second object-pixel and, subsequently, generates by interpolation as described above, additional vectors for object-pixels which have not been transformed.

In a preferred embodiment, the plurality of object-pixels in the image analysis method according to the invention have intensity values which are not the same as the intensity values of pixels which define the background in said digital image. Thus, object-pixels and background pixels (background pixels are also referred to herein also as “non-object pixels”), are mutually exclusive entities. Preferably, object-pixels are identified in a digital image by performing an image segmentation step.

In the field of machine vision, image segmentation can be used to identify and isolate objects comprised in the image from the background shown in the image. Typically, image segmentation thresholds, or binarizes, the image to distinguish or isolate objects of interest, such as people, faces, manufacturing goods, a fingerprint showing the friction ridges of the finger, a pattern on a semiconductor chip, and so on, from the background. Thus, such image segmentation divides the pixels comprised in a digital image into a group of pixels which belong to one or more objects (object pixels) and another group of pixels belonging to the background (non-object pixels).

Image segmentation can be performed in the conventional manner known in the art. In a preferred embodiment, the image segmentation comprises finding an intensity threshold. For example, a single threshold intensity value can be determined from an intensity histogram of the digital image. In one example, the threshold can be calculated using the formula:

threshold intensity=0.2*(mean image intensity)+0.8*(highest intensity)

Accordingly, when objects are characterized by bright shades (high pixel intensity values), an object pixel will preferably be a pixel having an intensity value which is larger than or equal to the determined threshold intensity. If the brightness of the image is inverted, i.e. the one or more object of interest appears dark in a bright background, it is preferred to invert the intensity values of the image before thresholding and analysis. In a particularly preferred embodiment, however, the threshold intensity value is predetermined, e.g., based on prior empirical analysis of images to determine an optimal absolute threshold or an optimal automated method to determine the threshold for each class of images.

In certain applications, use of a high threshold intensity value may result in portions of the object of interest being interpreted as background and, therefore, will result in poor segmentation. Likewise, use of a too low threshold intensity value may result in background being interpreted as objects of interest. To overcome these problems, more complex automated methods comprised in the art can be applied to find the threshold and, thus, the object pixels in the image (for example, see U.S. patent application, Ser. No. 2006/0170769).

In another preferred embodiment of the invention, the image analysis method according to the invention further comprises a data compression step and/or a selection step. Thus, in a preferred embodiment the method of the invention comprises a further step:
(c) selecting a subset of vectors in the vector dataset based on the directional component of the vectors in the vector dataset.

“Subset of vectors” means a part of the plurality of vectors comprised in the vector dataset. Step (c) may also be understood as selecting a number of vectors in the vector dataset, wherein said number is smaller than the total number of vectors comprised in the vector dataset. The selecting step (c) preferably selects vectors the positional component of which defines object-pixels which define the medial axis of the object. In one preferred embodiment, the method does not comprise step (b) and the selection step (c) is carried out after step (a). Thus, as also indicated in FIGS. 2 and 3, step (b) is preferably optional and steps (a) and (c) are preferably required. In another embodiment, the method comprises steps (a), (b) and (c) and these steps are carried out in that order. In the following, when reference is made to a “selection step” in the context with the method of the invention, said selection step refers to step (c) of the method of the invention. As used herein, the phrase “compression step” refers to a step of the method of the invention wherein vectors are selected in the vector dataset preferably by removing non-selected vectors from the vector dataset generated by the method of the invention. Thus, the purpose of the compression step is also the selection of a subset of vectors in the vector dataset. A selection in the compression step can also be achieved by not removing any vectors from the dataset but only by selecting vectors in the vector dataset. For example, an individual vector can be selected e.g. by storing a pointer to the selected vector in the vector dataset. A vector may also be selected by storing the vector data (e.g. its positional component, directional component and/or distance component) of the selected vector in a separate storage space, e.g. in the memory of a computer. Thus, as used herein, the phrase “compression step” merely refers to the action of selecting individual vectors from the plurality of vectors in the vector dataset by any means known in the art of informatics. A phrase of FIG. 1 refers to “Compressing/selecting vectors in the vector dataset based on their directional and positional component”. This phrase can also mean in preferred embodiments “Compressing the vector dataset by removing vectors based on their directional and positional component”. Said selection and/or compression step can also be applied to a vector dataset generated by the method of the invention, even when not all object-pixels of one or more objects in the digital image have been transformed into vectors using the method of the invention.

In a preferred embodiment, the data selection and/or compression step of the method of the invention comprises reducing the number of vectors present in the vector dataset. Thus, as will be apparent to the average skilled person in the art of computer science a compression/selection step, i.e. the selection step (c), does not necessarily require the reduction of the number of vectors from the vector dataset by removal of vectors from the vector dataset but can also be carried out, as stated above, by selecting vectors in the vector dataset. Thus, the compression/selection step may comprise removal of vectors from the vector dataset and/or a selection of vectors in the vector dataset. Preferably, the selection and/or compression step comprises comparing the directional component of at least one vector with the directional component of at least one other vector of the vector dataset. In a more preferred embodiment, the selection and/or compression step comprises comparing the directional components of at least two neighbouring vectors of the vector dataset with each other. In a further preferred embodiment, the selection and/or compression step does not compare any distance components of the vectors of the vector dataset with each other or with any variable or constant value. In this preferred embodiment of the selection and/or compression step, a vector is selected in and/or removed from the vector dataset, irrespective of the value of its distance component. Thus, preferably, in the selection and/or compression step no distance components of the vectors are used. In a further preferred embodiment, the selection and/or compression step removes a vector from the vector dataset if the neighbouring vectors of that vector have a directional component which is similar to the directional component of the vector. Two vectors have similar directional components if they form an angle which is smaller than 30%, smaller than 25%, smaller than 20%, smaller than 15%, smaller than 10%, or smaller than 5% of the angle which defines one complete circle. Preferably, at least one, two, three, four, five, six, seven, eight, nine, ten or more neighboring vectors are compared with the vector. It is preferred that in the selection step (c), vectors are selected by removing the remaining vectors, wherein the remaining vectors are groups of vectors having similar directional component values. In other words, in the selection step (c) vectors are preferably selected that have dissimilar directional components. Further preferred embodiments of the selection and/or compression step are provided below.

In the following, some references will be made to the figures, especially the flow-charts in order to illustrate the teaching of preferred embodiments of the method of the invention. These references only serve as examples and are not to be construed to limit the scope of the preferred embodiments in any way.

In a preferred embodiment, the method of the invention receives a digital image comprising one or more objects which will be transformed. As used herein, “receiving” a digital image comprises reading a digital image from a local storage device such as a hard disk, RAM, ROM, an EEPROM (for example flash memory), and/or an EPROM memory, or receiving a digital image from a digital imaging device capable of generating digital images or from a remote computer such as by receiving a video stream from, e.g., a broadcasting source which is sending, e.g. individual images in a video stream. Alternatively, the digital image may also be obtained (i.e. received) from a database comprising digital images such as the world wide web. This optional step of receiving a digital image is exemplified in step 100 in FIG. 1 and in step 100 in FIG. 2.

In a preferred embodiment of the image analysis method according to the invention, the step of transforming comprises the steps:
(i) selecting an object pixel (SOP) in the digital image;
(ii) selecting a circle (CC) which
   (a1) is centered at the selected object pixel (SOP); and
   (b1) contacts at least one object pixel; and
   (c1) contacts at least one non-object pixel or a group of non-object pixels;
(iii) selecting a pixel (P) that contacts the circle (CC) and defines the at least one vector which points from the selected object pixel (SOP) to the selected pixel (P); and
(iv) optionally storing and/or transmitting the at least one vector determined in step (iii).
   Thus, the above outlined preferred embodiment specifies that in step (a) of the method of the invention each vector is determined by carrying out at least the indicated steps (i) through (iv).

In a preferred embodiment, the steps of the image analysis method of the invention are carried out in the order (i), (ii), (iii) and, optionally, (iv). This preferred embodiment of the method of the invention is exemplified in step 102 in FIG. 1.

As used herein, “storing” means storing, for example a vector dataset, on a storage device such as a hard disk, RAM, ROM, an EEPROM (for example flash memory) and/or EPROM memory and “transmitting” or “sending” refers to sending the e.g. vector dataset to a remote computer or to a remote database or hardware set up to store and/or to quantify the data comprised in the vector dataset. In a preferred embodiment of the image analysis method, the non-object pixel is a pixel which is not an object-pixel and wherein the group of non-object pixels consists of pixels which are not object-pixels.

Preferably, the digital image comprises pixels that are ordered in sequentially numbered rows and sequentially numbered columns thereby forming a two-dimensional array of pixels. The method of the invention preferably sequentially processes all object-pixels comprised in the digital image or two-dimensional array of pixels as exemplified in FIG. 2, step 214. When a preferred method of the invention determines that an object-pixel in said two-dimensional array has not yet been transformed by the method of the invention, then step (i) of the preferred method selects this pixel as an object-pixel (SOP) and preferably stores the location of this selected object-pixel (SOP) in the two-dimensional array as the positional component of the corresponding vector. These steps are exemplified in steps 200 and 202 in FIG. 2.

As used herein, a “circle”, for example, the circle (CC) or the second circle (SCC), can also be a circle segment. Preferably, “circle” as used herein is a closed circle.

In step (ii) of the method of the invention, the circle (CC) is preferably selected from a group of circles each of which contacts not more non-object pixels than object-pixels. In FIG. 5A, a circle (CC) which fulfils this criterion has been selected for an exemplary selected object pixel (SOP). This circle (CC) shown in FIG. 5A also fulfils the criteria (ii)(a1), (ii)(b1) and (ii)(c1) as defined in step (ii) of the method of the invention. In agreement with criterion (ii)(c1), FIG. 5A shows an example of a non-object pixel which has been labelled “P” that is contacted by the selected circle (CC).

A person skilled in the art of information technology knows how to implement a method that selects the circle (CC) in step (ii). In one embodiment, the method of the invention preferably selects the circle (CC) in step (ii) by selecting its radius. As an example, a test-circle can be used, which is centered at the selected object pixel (SOP), and has an initial radius which is small, e.g. has a radius of at least 1 pixel, at least 2 pixels or at least 3 pixels. Next, the method preferably sequentially increases the radius of the test-circle as long as the test-circle does not either contact at least one non-object pixel or, preferably, a group of non-object pixels (see below). When the test-circle contacts at least one non-object pixel and/or a group of non-object pixels (see below), it is preferably selected as the circle (CC). By “sequentially increases” is meant that the radius is sequentially increased by a constant value, e.g. 1 pixel, or by a varying value. It is preferred that in step (ii) of the image analysis method of the invention, the circle which has the smallest radius of all circles that fulfil criteria (ii)(a1), (ii)(b1) and (ii)(c1) is selected as the circle (CC). The preferred selection process in step (ii) as described above is exemplified in FIG. 2 as step 204, 206 and 208.

A further disadvantage of prior art medial axis transform methods is that they are inaccurate when noise occurs within the object of interest which is analyzed. Thus, a single noise pixel inside the object may be interpreted (based on the threshold used for this image), to constitute a background pixel. In such cases, medial axis transform methods comprised in the art generate medial axis skeletons with poor accuracy. For example, see FIG. 14B.

Thus, it is preferred that in step (ii) of the image analysis method of the invention, the group of non-object pixels comprises at least two, three, or more non-object pixels wherein within said group of non-object pixels, each non-object pixel contacts at least one other non-object pixel of said group of non-object pixels. Preferably, the group of non-object pixels comprises at least 10%, 20%, 30%, 40%, 50%, 60%, 70%, 80%, 90%, 95%, or at least 99% of the non-object pixels which are contacted by the circle (CC). More preferably, the number of non-object pixels in said group of non-object pixels is preset to a value which exceeds the number of noise pixels that are likely to occur in individual noise spots or noise speckles which are aggregates of noise pixels that contact each other. Thus, in the case that a digital image contains fine “salt-and-pepper”-like noise pixels, wherein the noise pixels occur individually and not in groups of two or more noise-pixels which contact each other, then it is preferred that in step (ii) of the method of the invention the circle (CC) is selected such that it contacts a group of at least two non-object pixels. When the noise present in the image is of a coarser nature, it is preferred that a the number of non-object pixels in said group of non-object pixels at least exceeds the number of noise-pixels that are most frequently present in the coarse noise speckles, i.e. groups of noise pixels. An effective minimum number of non-object pixels in the group of non-object pixels can also be determined empirically. Thus, according to the preferred embodiment, the radius of the test circle is sequentially increased until it contacts a group of non-object pixels (which will, thus, constitute true background pixels), while individual noise pixels (see e.g., FIG. 5B, “NP1”) within the object are ignored, as can be seen e.g. in FIG. 5B. An exemplary result obtained by using such preferred noise-resistant embodiment of the method of the invention can be seen in FIG. 14C. Above outlined selection process is also exemplified in steps 204, 206 and 208 in FIG. 2.

If in step (ii) a circle (CC) is selected which in a preferred embodiment contacts a group of non-object pixels and if the circle which has the smallest radius of all circles that fulfil criteria (ii)(a1), (ii)(b1) and (ii)(c1) is selected as the circle (CC), then it is preferred that in criteria (ii)(c1) only circles, that contact a group of non-object pixels are considered for the selection.

Once the circle (CC) has been selected as described above, its radius is preferably stored as the distance component of the vector, as shown e.g. in step 210 in FIG. 2.

In a preferred embodiment of the image analysis method of the invention, the pixel (P) is selected from a group consisting of the non-object pixels of said group of non-object pixels. In other words: preferably one of the non-object pixel(s) contacted by the circle (CC) in step (ii)(c1) is selected as pixel (P) in step (iii). Image analysis methods which comprise this preferred embodiment can store the direction, in which the selected pixel (P) (according to this embodiment a member of said group of non-object pixels), is localized with respect to the selected object pixel (SOP) as directional component of the vector (see also step 212 in FIG. 2). Thus, by selecting the pixel (P), all components (i.e., distance, positional and directional component) of the vector are known and the selected object pixel (SOP) has been transformed and the vector can, according to optional step (iv), be stored and/or transmitted. This embodiment is useful for analyzing images in time critical applications and/or when no improvement of the directional component of the vector is required, i.e. when the pixel (P) is not selected by an alternative way (see below).

Another disadvantage of medial axis transform methods comprised in the art is that they are time consuming and therefore inefficient. In contrast, the image analysis method of the invention provides at least three features that minimize the computational load of the method of the invention. First, the powerful noise suppression features of the image analysis method of the invention overcome noise which may be present in the background (see below) and/or in the one or more object (see above). This obviates time consuming pre-processing steps that suppress noise in the digital image prior to the analysis such as, for example, by applying a median filter. Second, an efficient selection and/or compression step (see above and below) achieves the generation of a compressed vector dataset which only comprises vectors the positional components of which constitute a medial axis of the object. Thus, no time consuming additional trimming and post-processing steps are required to isolate the medial axis from a preliminary medial axis dataset as is the case when using image analysis methods comprised in the art. Third, a preferred embodiment is provided to dramatically accelerate the circle selection step (ii) of the image analysis method of the invention which will be outlined in the following.

It is a surprising finding that the absolute value of the difference between two distance components of two vectors of two transformed object-pixels of the same object in the digital image is generally smaller or equal to the distance between these two transformed object pixels (for example, see also FIG. 6D). This dependency can be used to significantly accelerate the circle (CC) selection step (ii) of the method of the invention. For example, when an object-pixel which contacts the selected object pixel (SOP) has been transformed into a vector (also referred to as “contacting vector”) in a previous transformation step (i.e. the distance component of the contacting vector is known), then for the transformation of the selected object pixel (SOP), the selection step (ii) preferably selects the circle (CC) out of a group consisting of only three circles. Specifically, said three circles fulfil the criteria (ii)(a1), (ii)(b1) and have a radius which equals the distance component of the contacting vector −1 pixel, +0 pixel or +1 pixel, respectively. Thus, step (ii) of the method will only require to select one of these three circles which fulfils also criterion (ii)(c1), i.e. which contacts at least one non-object pixel or a group of non-object pixels. Consequently, if in a preferred embodiment, not every object pixel is transformed and/or the distance between the selected object pixel (SOP) and a previously transformed object pixel is, e.g., 2 pixels, then the circle (CC) for the selected object pixel (SOP) is preferably selected from a group consisting of maximally five circles (distance component of neighbouring vector +2, +1, +0, −1, and −2 pixels) and so forth. The example in FIG. 17 shows the significant execution time improvement obtainable by the preferred embodiments described above.

Thus, preferred is the image analysis method according to the invention, wherein in step (ii) the circle (CC) is selected from a group of circles each of which has a radius which does not differ by more than 1, 2, 3, 4, 5, 6, 7, 8, 9 or more than 10 pixels from the distance component of a vector of a previously transformed object-pixel which either contacts the selected object pixel (SOP) or which is localized not farther than 2, 3, 4, 5, 6, 7, 8, 9 or 10 pixels away from the selected object pixel (SOP). “Previously transformed object-pixel” means that said object-pixel has already been transformed by the method of the invention, i.e., that a corresponding vector is available for this object-pixel. Such preferred embodiment may, for example, be realized in step 204 of FIG. 2, wherein the initial radius of the test-circle could be set to the distance component of the vector of a previously transformed object-pixel which contacts the selected object pixel (SOP) minus 1.

Thus, using standard hardware comprised in the art, the method of the invention is capable of generating transformations of pixel arrays, i.e. of digital images in extremely rapid fashion, thus allowing real-time (e.g. 30 frames per second) image analysis which can be applied in virtually any technical appliance that relies on robotic vision and/or depends on a fast computer-implemented image analysis.

Preferred is also the method of the invention, wherein a non-object pixel that contacts the circle (CC) is selected as the pixel (P). This embodiment can, e.g., be useful in case that no noise is present in the image and the circle (CC) is selected such that it contacts one or more non-object pixels (preferably one non-object pixel) and when it is not desired to improve the accuracy of the directional component of the vector (see below).

In the context of the embodiments of the present invention it is preferred to achieve an improved accuracy of the directional component of the vectors of the vector dataset because the directional components are preferably used to compress the vector dataset and the accuracy and efficiency of the selection and/or compression step depends on the accuracy of the directional components. While the multiplicity of the vectors comprised in the vector dataset accurately defines the shape of the analyzed object or objects, it is preferred to compress this vector dataset in order to isolate those vectors the positional components of which define the medial axis of the one or more objects.

For example, the accuracy of the directional component of a vector can be improved when in FIG. 2 step 212 is replaced with the steps depicted in FIG. 3.

Thus, further preferred is also the image analysis method according to the invention, wherein in step (iii), a pixel which contacts the circle (CC) and which is located equidistant to two pixels each of which is localized at an intersection between
a second circle (SCC) which
(a2) is centered at the selected object pixel (SOP); and
(b2) contacts at least one object pixel; and
(c2) contacts at least one non-object pixel; and
(d2) has a radius which is larger than the radius of the circle (CC); and
(e2) which contacts not more non-object pixels than object pixels; and
the boundary of the object in said digital image that comprises the selected object pixel (SOP),
   is selected as the pixel (P).

Thus, in a preferred embodiment the method of the invention comprises above outlined procedure for selecting the pixel (P). As the orientation of the vector is defined in preferred embodiments via the selected object pixel (SOP) and the pixel (P), this preferred selection will adjust or set the directional component of the vector. Thus, preferably this embodiment is used as the adjusting step (b) of the method of the invention. It is further preferred that, despite the designation “adjusting step (b)”, above outlined adjusting step (b) replaces step (iii) in method step (a).

A second circle (SCC) centered around an exemplary selected object pixel (SOP) and which further fulfils the criteria (b2) through (e2) as defined above is depicted in FIG. 5A. In this figure, the pixels at said intersection are depicted and labeled as “IN”. According to the preferred embodiment, the pixel which contacts the circle (CC) and which is located equidistant to two “IN” pixels is shown as “P′”. The vector which points from the selected object pixel (SOP) to the selected pixel (P) selected as described above (pixel P′ in FIG. 5A) is shown as a dashed arrow. The directional component of this vector more accurately reflects the desired surface normal direction. As can also be seen in FIG. 5A this preferred image analysis method is robust, i.e. the accuracy of the vector is not compromised by an uneven or noisy boundary of the object.

A further disadvantage of prior art medial axis transform methods is that they are inaccurate when noise occurs in the background of the digital image which is analyzed (for example, see FIG. 5B, noise pixel “NP2” and FIG. 13C for the effect that noise can have on an image analysis method).

Thus, further preferred is the image analysis method according to the invention, wherein the intersection between the boundary of the object and the second circle (SCC) is the location of a group of pixels, wherein:
(a3) the group of pixels comprises at least one non-object pixel and at least two, three, four, five, six, or more object-pixels; and
(b3) all pixels of said group of pixels contact the second circle (SCC); and
(c3) each object-pixel in said group of pixels contacts at least one other object-pixel in said group of pixels.
   In the above outlined embodiment, said non-object pixel contacts one of said object-pixels within said group of pixels. Thus, according to this preferred embodiment, each of the two intersections mentioned in step (b) between the boundary of the object and the second circle (SCC) are furthermore defined by the presence of a group of pixels, wherein the pixels meet the above-outlined criteria (a3) through (c3).

According to the preferred embodiment above, noise pixels (false-positive object-pixels) which are located outside of the object and which contact the second circle (SCC) will be ignored, i.e. they cannot define an intersection between the boundary of the object and the second circle (SCC) (see FIG. 5B for an example). It is preferred that the number of object-pixels comprised in said group of pixels exceeds the number of noise object-pixels which are statistically comprised in noise spots in the digital image. For example, in cases when “salt-and-pepper”-like noise pixels as defined above are present in the image, it is preferred that said group of pixels comprises at least one non-object pixel and at least two object-pixels or, more preferably, said group of pixels consists of one non-object pixel and two object-pixels. A most preferred embodiment of the method which incorporates the preferred methods described above is exemplified in FIG. 3, step 300 through 318. To select the pixel “P” in this most preferred embodiment, the average between the “first direction” and the “second direction” (see steps 308, 316 and 318) is determined. Thus, the pixel “P”, contacting the circle (CC), is localized equidistantly between two object-second circle (SCC) intersections as required in this preferred embodiment of the method of the invention. For an example of the technical effect employing this embodiment of the method of the invention to a “noisy” digital image, see also FIG. 13.

In the following, the preferred embodiments of the method of the invention which comprise a selection and/or compression step will be described in more detail. The goal of the compression step is to remove all vectors from the vector dataset, generated by the method of the invention, which do not belong to the medial axis of the one or more objects, i.e. which have a positional component (SOP locations) that does not define a location on the medial axis. Similarly, such vectors describing the medial axis can be selected in the selection step (c) of the method of the invention. Surprisingly, the directional and positional components of the vectors in the vector dataset constitute the necessary and sufficient information with which the preferred selection and/or compression steps are realized. In one preferred selection and/or compression step, the directional components of at least two neighboring vectors are compared. Thus, in a preferred embodiment of the image analysis method of the invention the selection step (c) comprises or consists of comparing the directional components of at least two neighbouring vectors of the vector dataset with each other. As used herein, “neighboring vectors” are vectors the positional component of which define locations which are in close proximity to each other, preferably the distance between said locations is not greater than 1, 2, 3, 4, 5, 6, 7, 8, 9, 10 or more pixels, preferably no greater than 3 pixels and most preferably no greater than 2 pixel. The concept of the selection and/or compression step according to the method of the invention is based on the observation that vectors neighboring the medial axis of an object exhibit dissimilar directional components, i.e. directional components which differ preferably by at least 30°, 40°, 50°, 60°, 70°, 80°, 90°, 100°, 110°, 120°, 130°, 140°, 150°, 160°, or at least by 170° (for example, see also FIG. 6C).

Thus, in a further preferred embodiment, the method comprises a selection step (c), wherein in the selection step (c) vectors are selected if they contact each other and if they have unequal directional components. Thus, preferably pairs of vectors are selected. Preferably, said selected vectors contact each other and have directional components that differ from each other by more than about 5%, 6%, 7%, 8%, 9%, 10%, 11%, 12%, 13%, 14%, 15%, 16%, 17%, 18%, 19%, 20%, 21%, 22%, 23%, 24% or more than about 25%, preferably by more than about 10% or 12.5% and most preferably by more than about 12.5% of the of the angle which defines one complete circle. It is preferable to choose for the selection step (c) a sufficiently large angle that is formed by the directional components of two contacting vectors such that at least 95%, 96%, 97%, 98%, 99%, 99.5% or 99.9% and most preferably such that at least 98% of all selected vectors have a distance component that forms a local maximum with respect to the distance components of at least eight neighbouring vectors and/or that is larger than the distance components of at least three contacting vectors. In another preferred embodiment, in the selection step (c) vectors are selected, if they contact each other and if the difference between their directional components is larger than a threshold angle that is selected from the group of threshold angles that comprises angles that lie between 8% and 25% of the angle which defines one complete circle.

In a further preferred embodiment, the method comprises a selection step (c), wherein in the selection step (c) vectors are selected if they contact each other and/or have directional components that are sufficiently dissimilar such that at least 80%, 90%, 92%, 94%, 95%, 98% or at least 99% or more of those vectors are selected that belong to the medial axis of said object (i.e. said vectors comprise a positional component that defines a pixel on the medial axis of said object.).

Thus, preferred is the image analysis method of the invention, wherein the selection and/or compression step comprises a step of removing from said vector dataset a vector, if the vector does not have at least two neighbouring vectors, each of which forms with the vector an angle which is larger than about one twelfth, one eleventh, one tenth, one ninth, one eighth, one seventh, one sixth, one fifth or larger than one quarter of the maximum angle which defines one complete circle. Most preferably, the angle is larger than about one eighth of the maximum angle which defines one complete circle.

Especially preferred is the image analysis method of the invention, wherein said selection and/or compression step comprises a step of removing from said vector dataset a vector, if the vector does not fulfil the following two conditions:
(1) the vector has at least three neighbouring vectors each of which forms with the vector an angle which is larger than about one twelfth, one eleventh, one tenth, one ninth, one eighth, one seventh, one sixth, one fifth or larger than about one quarter of the maximum angle which defines one complete circle; and
(2) the vector has at least three neighbouring vectors each of which forms with the vector an angle which is smaller or equal than about one twelfth, one eleventh, one tenth, one ninth, one eighth, one seventh, one sixth, one fifth or smaller or equal than about one quarter of the maximum angle which defines one complete circle.
   Thus, the selection step (c) of the method of the invention is preferably carried out by removing from said vector dataset vectors that fulfil criteria (1) and (2) as outlined above. Alternatively, the selection step (c) can be carried out by selecting vectors that fulfil the following two conditions:
(1) the vector has at least three neighbouring vectors each of which forms with the vector an angle which is larger than about one twelfth, one eleventh, one tenth, one ninth, one eighth, one seventh, one sixth, one fifth or larger than about one quarter of the maximum angle which defines one complete circle; and
(2) the vector has at least three neighbouring vectors each of which forms with the vector an angle which is smaller or equal than about one twelfth, one eleventh, one tenth, one ninth, one eighth, one seventh, one sixth, one fifth or smaller or equal than about one quarter of the maximum angle which defines one complete circle.

A Preferred embodiment of the selection and/or compression step described above is exemplified in steps 402, 404 and 406 of FIG. 4. Preferably, as used herein, one complete circle corresponds to an angle of 360° or 2π.

As defined in the first aspect of the invention, the at least one vector comprises a positional component, a directional component and a distance component.

Thus, a further preferred embodiment is the image analysis method of the invention, wherein step (iii) comprises the step of storing the location of the selected object pixel (SOP) in the digital image as the positional component of the at least one vector. This embodiment is exemplified in step 202 of FIG. 2.

Further preferred is the image analysis method according to the invention, wherein step (iii) comprises the step of storing the direction in which the pixel (P) is localized with respect to the selected object pixel (SOP) as the directional component of the at least one vector. This embodiment is exemplified in step 212 of FIG. 2 and/or in step 318 of FIG. 3. It is known in the art how to determine the angle between two points and, thus, the directional component. In a preferred embodiment the directional component is determined using an inverse trigonometric function comprised in the art, for example by using an arctan function.

Also preferred is the image analysis method according to the invention, wherein step (iii) comprises the step of storing the radius of the circle (CC) as the distance component of the at least one vector. This embodiment is exemplified in step 210 of FIG. 2.

As will be clear to the skilled person, the directional, distance and positional component of a vector can preferably each individually be stored at any time and/or in any order and/or also in multiple instances in the method of the invention, from the instant on that the respective value is determined by carrying out the method of the invention.

Please also refer to FIG. 6. visualizing the values of the directional, positional and distance components of a multiplicity of vectors.

In summary, the image analysis method of the present invention does not rely on determining inscribed circles but rather transforms object-pixels into vectors which comprise a positional component, a directional component and a distance component. As is described above in detail, the positional and directional component can be used to compress the vector dataset and/or to select a subset of vectors that describe the medial axis of the object, while the distance and the positional component can be used to accelerate the selection step (ii) by limiting the number of possible circles that the circle (CC) is selected from. As mentioned before, in the various preferred embodiments described herein, the determined vectors are preferably surface normal vectors pointing from object pixels to the proximal surface of the object.

In a further aspect the invention provides a computer program product stored on a computer readable storage medium comprising a computer-readable program code for causing a data processing system to carry out the image analysis method according to the invention.

In a further aspect the invention provides an apparatus for carrying out the image analysis method according to the invention.

In a preferred embodiment, the invention provides the apparatus of the invention, wherein the apparatus comprises an electronic integrated circuit capable of carrying out the image analysis method according to the invention; wherein said method is not implemented as a program but as an electronic integrated circuit.

Further preferred is the apparatus of the invention, wherein the electronic integrated circuit is an application-specific integrated circuit (ASIC).

In a further aspect the invention provides a data processing system comprising a memory device, an operating system and the computer program product according to the invention which is loaded into the memory device of said data processing system and wherein the data processing system is capable of carrying out or is carrying out the image analysis method according to the invention.

In a further aspect the invention provides an image analysis system comprising an imaging device and the data processing system of the invention or the apparatus according to the invention; wherein the imaging device is capable of acquiring or acquires digital images and wherein the acquired digital images are transferred to said data processing system or said apparatus.

Virtually any imaging device capable of generating a digital image from sensor data can be used in the image analysis of the invention. Thus, in a preferred embodiment, the imaging device of the image analysis system of the invention is selected from the group consisting of a digital camera, a computed tomography (CT) scanner, a magnetic resonance imaging (MRI) scanner, a positron emission tomography (PET) scanner, an ultrasonograph, an echo sonar, a night vision device, a flat-bed scanner, a database comprising one or more images, a fingerprinting device, a fax machine, a radar equipment and an X-ray imaging device.

Further preferred is the image analysis system according to the invention, wherein the digital camera is mounted on a microscope or an endoscope. In a preferred embodiment, the microscope of the image analysis system is a light microscope or an electron microscope. The light microscope is preferably selected from the group consisting of a confocal microscope, an epi-fluorescence microscope, a thin light sheet microscope (TLSM) and a single-plane illumination microscope (SPIM). Most preferably, the light microscope is a high-throughput microscope, preferably capable of taking digital images of a multi-well plate.

As will be evident to a skilled person, the vector datasets generated by any of the embodiments of the method of the invention can also be analyzed and subsequently used to automatically control the activity of a process or an electrical device which is preferably external of the apparatus, data processing system or image analysis system of the invention. In a preferred embodiment, the electrical device comprises a device that is selected from the group consisting of a visual or acoustic signalling device (e.g. an alarm siren or a flashing light), an electric motor, a hydraulic system, a heating device, a targeting system, an electric lock, a compressor, a combustion engine and many more. In one example, the lane recognition system described in the patent application US 2007/198188 requires the aid of an object detection system to detect objects and/or edges. This detection component can in one embodiment be substituted with the novel image analysis method of the invention to achieve a faster, more robust and more versatile object recognition.

In a further aspect the invention provides a system for controlling a vehicle traveling on a road, comprising:
(a4) a vehicle; and
(b4) an image analysis system according to the invention, wherein the imaging device is a digital camera, a night vision device and/or a radar equipment; and
(c4) optionally a computational device which receives at least one vector dataset from the image analysis system and determines the relative position and the relative velocity of detected objects with respect to the position and velocity of the controlled vehicle; and
(d4) optionally a controlling device which receives the computed data from the computational device and controls the direction in which the vehicle is driving and the vehicle's velocity such as to prevent the vehicle form leaving the sides of the road and/or to prevent a collision with an object on the road.

In preferred embodiments of the system for controlling a vehicle traveling on a road, the aspects and preferred embodiments disclosed in US 2007/198188 are combined with the image analysis system according to the present invention, e.g. by enhancing the object detection system in US 2007/198188 with the image analysis system according to the present invention. It is additionally or alternatively preferred that all components of the system for controlling a vehicle traveling on a road are mounted on said vehicle. The control system of the present invention is useful as vectors can be determined for objects captured by the imaging device which may represent a hazard to the driver of the vehicle and/or the vehicle itself. Using the determined vectors and the velocity of the vehicle, approaching objects can be detected by their increase in size over time. In this context, it may, thus, be advantageous to analyze a series of images that are received from said imaging device. Also the presence and shape of objects on or near the road can be detected, including in preferred embodiments the recognition of letters on a road sign or on a traffic information screen. The controlling system according to the present invention can also be used to prevent the vehicle from passing a non-pass side-strip and/or prevent it from crashing into other cars, passengers, reflector posts and the like. In one preferred embodiment the driver of the vehicle is warned via an acoustic or vibration alarm if the vehicle passes a non-pass side-strip or if the vehicle is predicted to collide with a physical object on the road.

The many areas of industrial use for such image analysis methods comprise: Medical image analysis (e.g. microscopy and biomedical image analysis, e.g. for vascular visualization (see US 2006/0122539) and/or for the analysis of neuronal networks), traffic control (e.g. vehicle guidance and path recognition—see also above), product quality control (e.g. validation of manufactured parts on a conveyor belt), semiconductor chip manufacturing (e.g. topography quality control and/or connector quality control, for example by replacing the image analysis system in U.S. Pat. No. 5,861,909 A1 with the method of the invention), information management (e.g. similarity searches for similar images in a database such as in the world wide web; e.g. http://photo.beholdsearch.com/search.jsp), image compression (e.g. see U.S. Pat. No. 7,024,040) and text recognition (see U.S. Pat. No. 6,157,750).

If the image analysis method of the invention is used for a similarity search then preferably the compressed dataset is further analyzed by methods comprised in the art, e.g. as disclosed in US 2007/192316.

In a further aspect the invention also provides a use of the image analysis method according to the invention, the data processing system of the invention, the apparatus according to the invention, or the image analysis system according to the invention in an application selected from the group of medical image analysis (e.g. for ex vivo diagnostics), traffic control, vehicle guidance, automated product quality control, semiconductor chip topography quality control, semiconductor chip connector quality control, microscopy image analysis, similarity searches for similar digital images in a database, digital image compression and text recognition.

In another preferred embodiment, the method of the invention is used to generate a shape descriptor which is an abstract representation of a shape. Methods to generate shape descriptors are known in the art and can effectively be applied to, e.g., motion video compression/decompression and image searching techniques based on a motion video compression technique such is used in MPEG compression and decompression methods especially MPEG-7 compression/decompression methods.

Additionally, the method of the present invention can also be, as needed, combined with other image analysis methods comprised in the art. Furthermore, in another preferred embodiment, digital images can be analyzed by the method of the invention either individually, e.g. image by image or in a batch process, e.g. images are first grouped and then the group of images is analyzed.

Also the following items are part of the invention:

In a first item: an image analysis method for analyzing a digital image comprising a plurality of object-pixels that define at least one object in said digital image, wherein the image analysis method comprises the step of transforming at least one object-pixel into at least one vector in a vector dataset and wherein the at least one vector comprises a positional component, a directional component and a distance component.

In a second item: the image analysis method according to item 1, wherein the plurality of object-pixels have intensity values which are not the same as the intensity values of pixels which define the background in said digital image.

In a third item: the image analysis method according to item 1 or 2, further comprising a data compression step.

In a fourth item: the image analysis method according to item 3, wherein the data compression step comprises reducing the number of vectors present in the vector dataset.

In a fifth item: the image analysis method according to items 3 or 4, wherein the compression step comprises comparing the directional component of at least one vector with the directional component of at least one other vector of the vector dataset.

In a sixth item: the image analysis method according to item 5, wherein the compression step comprises comparing the directional components of at least two neighbouring vectors of the vector dataset with each other.

In a seventh item: the image analysis method according to item 5 or 6, wherein the compression step does not compare any distance components of the vectors of the vector dataset with each other or with any variable or constant value.

In an eights item: the image analysis method according to any of items 1 to 7, wherein the step of transforming comprises the steps:
(i) selecting an object pixel (SOP) in the digital image;
(ii) selecting a circle (CC) which
   (a1) is centered at the selected object pixel (SOP); and
   (b1) contacts at least one object pixel; and
   (c1) contacts at least one non-object pixel or a group of non-object pixels;
(iii) selecting a pixel (P) that contacts the circle (CC) and defines the at least one vector which points from the selected object pixel (SOP) to the selected pixel (P); and
(iv) optionally storing and/or transmitting the at least one vector determined in step (iii).

In a ninth item: the image analysis method according to item 8, wherein the non-object pixel is a pixel which is not an object-pixel and wherein the group of non-object pixels consists of pixels which are not object-pixels.

In a tenth item: the image analysis method according to item 8 or 9, wherein in step (ii) the circle (CC) is selected from a group of circles each of which contacts not more non-object pixels than object-pixels.

In an eleventh item: the image analysis method according to any of items 8 to 10, wherein the group of non-object pixels comprises at least two non-object pixels and wherein within said group of non-object pixels, each non-object pixel contacts at least one other non-object pixel of said group of non-object pixels.

In a twelfth item: the image analysis method according to any of items 8 to 11, wherein the pixel (P) is selected from a group consisting of the non-object pixels of said group of non-object pixels.

In a thirteenth item: the image analysis method according to any of items 8 to 12, wherein in step (ii) the circle which has the smallest radius of all circles that fulfil criteria (ii)(a1), (ii)(b1) and (ii)(c1) is selected as the circle (CC).

In a fourteenth item: the image analysis method according to any of items 8 to 13, wherein in step (ii) the circle (CC) is selected from a group of circles each of which has a radius which does not differ by more than 10 pixels from the distance component of a vector of a previously transformed object-pixel which either contacts the selected object pixel (SOP) or which is localized not farther than 10 pixels away from the selected object pixel (SOP).

In a fifteenth item: the image analysis method according to any of items 8 to 14, wherein a non-object pixel that contacts the circle (CC) is selected as the pixel (P).

In a sixteenth item: the image analysis method according to any of items 8 to 11 and 13 to 14, wherein in step (iii), a pixel which contacts the circle (CC) and which is located equidistant to two pixels each of which is localized at an intersection between

a second circle (SCC) which
(a2) is centered at the selected object pixel (SOP); and
(b2) contacts at least one object pixel; and
(c2) contacts at least one non-object pixel; and
(d2) has a radius which is larger than the radius of the circle (CC); and
(e2) which contacts not more non-object pixels than object pixels;
   and
   the boundary of the object in said digital image that comprises the selected object pixel (SOP), is selected as the pixel (P).

In a seventeenth item: the image analysis method according to item 16, wherein the intersection between the boundary of the object and the second circle (SCC) is the location of a group of pixels, wherein:
(a3) the group of pixels comprises at least one non-object pixel and at least two object-pixels; and
(b3) all pixels of said group of pixels contact the second circle (SCC); and
(c3) each object-pixel in said group of pixels contacts at least one other object-pixel in said group of pixels.

In a eighteenth item: the image analysis method of any of items 3 to 17, wherein the compression step comprises a step of removing from said vector dataset a vector, if the vector does not have at least two neighbouring vectors, each of which forms with the vector an angle which is larger than one eighth of the maximum angle which defines one complete circle.

In a nineteenth item: the image analysis method of any of items 3 to 18, wherein said compression step comprises a step of removing from said vector dataset a vector if the vector does not fulfil the following two conditions:
(1) the vector has at least three neighbouring vectors each of which forms with the vector an angle which is larger than one eighth of the maximum angle which defines one complete circle; and
(2) the vector has at least three neighbouring vectors each of which forms with the vector an angle which is smaller or equal than one eighth of the maximum angle which defines one complete circle.

In a twentieth item: the image analysis method according to any of items 8 to 19, wherein step (iii) comprises the step of storing the location of the selected object pixel (SOP) in the digital image as the positional component of the at least one vector.

In a twenty first item: the image analysis method according to any of items 8 to 20, wherein step (iii) comprises the step of storing the direction in which the pixel (P) is localized with respect to the selected object pixel (SOP) as the directional component of the at least one vector.

In a twenty second item: the image analysis method according to any of items 8 to 21, wherein step (iii) comprises the step of storing the radius of the circle (CC) as the distance component of the at least one vector.

In a twenty third item: a computer program product stored on a computer readable storage medium comprising a computer-readable program code for causing a data processing system to carry out the image analysis method according to any of items 1 to 22.

In a twenty fourth item: apparatus for carrying out the image analysis method according to any of items 1 to 22.

In a twenty fifth item: the apparatus of item 24, wherein the apparatus comprises an electronic integrated circuit capable of carrying out the image analysis method according to any of items 1 to 22; wherein said method is not implemented as a program but as an electronic integrated circuit.

In a twenty sixth item: the apparatus of item 25, wherein the electronic integrated circuit is an application-specific integrated circuit (ASIC).

In a twenty seventh item: data processing system comprising a memory device, an operating system and the computer program product according to item 23 which is loaded into the memory device of said data processing system and wherein the data processing system is capable of carrying out the image analysis method according to any of items 1 to 22.

In a twenty eighth item: image analysis system comprising an imaging device and the data processing system of item 27 or the apparatus according to any of items 24 to 26; wherein the imaging device is capable of acquiring digital images and wherein the acquired digital images are transferred to said data processing system or said apparatus.

In a twenty ninth item: the image analysis system of item 28, wherein the imaging device is selected from the group consisting of a digital camera, a computed tomography (CT) scanner, a magnetic resonance imaging (MRI) scanner, a positron emission tomography (PET) scanner, an ultrasonograph, an echo sonar, a night vision device, a flat-bed scanner, a database comprising one or more images, a fingerprinting device, a fax machine, a radar equipment and an X-ray imaging device.

In a thirtieth item: the image analysis system according to item 29, wherein the digital camera is mounted on a microscope or an endoscope.

In a thirty first item: the image analysis system according to item 30, wherein the microscope is a light microscope or an electron microscope.

In a thirty second item: system for controlling a vehicle travelling on a road, comprising:
(a4) a vehicle; and
(b4) an image analysis system according to item 29, wherein the imaging device is a digital camera, a night vision device and/or a radar equipment; and
(c4) optionally a computational device which receives at least one vector dataset from the image analysis system and determines the relative position and the relative velocity of detected objects with respect to the position and velocity of the controlled vehicle; and
(d4) optionally a controlling device which receives the computed data from the computational device and controls the direction in which the vehicle is driving and the vehicle's velocity such as to prevent the vehicle form leaving the sides of the road and/or to prevent a collision with an object on the road.

And, in a thirty third item: use of the image analysis method according to any of items 1 to 22, the data processing system of item 27, the apparatus according to any of items 24 to 26, or the image analysis system according to any of items 28, to 31 in an application selected from the group consisting of medical image analysis, traffic control, vehicle guidance, automated product quality control, semiconductor chip topography quality control, semiconductor chip connector quality control, microscopy image analysis, similarity searches for similar digital images in a database, digital image compression and text recognition.

Various modifications and variations of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant fields are intended to be covered by the present invention.

The following examples and figures are merely illustrative of the present invention and should not be construed to limit the scope of the invention as indicated by the appended claims in any way.

### BRIEF DESCRIPTION OF THE FIGURES

In the following, the content of the figures comprised in this specification is described. Please also refer to the detailed description of the invention above.

FIG. 1: This figure is a flow chart providing an overview of a preferred embodiment of the method of the invention. Optional steps are indicated by dashed arrows and/or dashed boxes.

FIG. 2: This figure is a flow chart showing the step 102 in the flow chart of FIG. 1. The figure shows one preferred method of determining the positional component, the distance component and the directional component of each vector (all highlighted by an underscore). The dashed arrows pointing to and from “FIG. 3” indicate that in a preferred embodiment, the method depicted in the flow chart on FIG. 3 replaces step 212.

FIG. 3: This figure is a flow chart showing an optional series of steps which adjusts, i.e. enhances the accuracy of the directional component of the vector. The depicted steps preferably replace step 212 of FIG. 2.

FIG. 4: This figure is a flow chart showing the optional step 104 in the flow chart of FIGS. 1 and 2.

FIG. 5A: A reference diagram for the determining step (a) and the adjustment step (b) according to the method of the invention is shown. The object in the digital image is composed of object pixels. The image analysis method of the invention selects one object pixel which is referred to as ‘selected object pixel’ (SOP). The method also determines a circle (CC) which is centered at the selected object pixel (SOP) and contacts at least one object-pixel. The circle (CC) is not inscribed but contacts also at least a non-object pixel, for example, the pixel indicated by (P). Preferably, the circle (CC) contacts as few non-object pixels as possible. The method of the invention also determines a vector which originates at the selected object pixel (SOP) and which terminates at a selected pixel (P) which contacts the circle (CC). In this example, the pixel (P) is a non-object pixel. However, in this example, the vector, which points from (SOP) to (P), is not accurately oriented orthogonally to the boundary of the object. Thus, in a preferred embodiment, the distance component of the vector may be adjusted. Thus, the method of the invention preferably selects pixel (P′) as selected pixel (P). Pixel (P′) also contacts the circle (CC) but it is additionally located equidistant to two other pixels (IN) each of which is localized at an intersection between the boundary of the object and a second circle (SCC) which has a larger radius than the circle (CC), is centered at the selected object pixel (SOP), contacts at least one object pixel and contacts at least one non-object pixel.

FIG. 5B The object in the digital image is composed of object pixels. However, it may also comprise one or more noise pixels. One example of a noise pixel which is localized in the object is shown (labeled NP1). Also a noise pixel in the background is shown (labeled NP2). In a preferred embodiment, the circle IC merely contacts a noise pixel and not a group of non-object pixels and is, thus, in preferred embodiments not a selected circle (CC). The selected circle (CC) in this example contacts a group of pixels comprising three non-object pixels (white circles). In this example, the second circle (SCC) intersects the boundary of the object at locations which are characterized by the presence of a group of pixels comprising at least three object-pixels (black circles) and at least one non-object pixel (white circle). In this example the selected object pixel (SOP) is not a noise pixel. However, also the selected object pixel (SOP) may be a noise pixel which is located within the object. For reasons of clarity, not all object-pixels of the object are indicated as black circles but only exemplary object-pixels of the object are highlighted as black circles.

FIG. 6: Exemplary visualization of a vector dataset generated from an object (here the object is depicted in white as shown in panel B) which is comprised of object pixels (OP) and non-object pixels (NOP). In this example, a vector is generated for each object pixel. The magnitude of the directional component and the distance component of each vector is visualized in grey shades in panels (C) and (D), respectively. Panel (A) exemplifies which grey shade in (C) corresponds to which directional angle (measured preferably in degrees). In this example, a large value of a distance component corresponds to a light grey shade (as shown in panel D) and a small value (i.e. short distance) corresponds to a dark grey shade. Preferably, no vector data is generated for non-object pixels (NOP) which are indicated in (C) and (D) as checkerboard pattern.

FIG. 7: As shown in FIG. 2, in a preferred embodiment of the invention, a vector is generated for each object pixel resulting in a vector dataset. In a more preferred embodiment, vectors are removed from such vector dataset in a subsequent selection and/or compression step to form a vector ‘skeleton’. In this figure, a digital image (A) comprising a sample object is transformed and the vector dataset is compressed using an embodiment of the method of the invention. The locations defined by the positional components of the vectors in the vector dataset are visualized in (B). In panel (C) about 10% of the vectors of the vector dataset shown in (B) are visualized as arrows. The plurality of vectors in the vector dataset thus define the position, orientation, dimension and representative points on the boundary of the object in the digital image. When applying a medial axis method comprised in the art (e.g. U.S. Pat. No. 5,023,920) to the same digital image (A), an inferior vector skeleton dataset is obtained (D) which only comprises the positional information of maximal squares but lacks accuracy and the directional component.

FIG. 8: Example of an image analysis according to the method of the invention. The image analysis method of the invention was applied to a digital microscopy image of fluorescent C. elegans nematodes (fluorescent light microscopic photography; 20× magnification) (A). Panel (C) visualizes the threshold intensity used to delimit object pixels (in black rendering) from background (in light rendering). The positional components of the compressed vector dataset resultant from the analysis and about 10% of all vectors comprised in the compressed vector dataset (arrows) are visualized in (B). This example also shows that a digital image comprising more than one object can be analyzed using the method of the invention. Using the vector information one can easily determine e.g. the number of objects, their circumference, area, orientation, width, length and medial axis. For example analysing the vector dataset derived from the depicted image, a total of 11 objects were identified having an average thickness of 24.93 pixels and an average orientation of 130.4° (for the angle see also FIG. 6A).

FIG. 9: Example of an image analysis according to the method of the invention. The image analysis method of the invention was applied to a digital image comprising mechanical parts on a conveyor belt (A). Panel (C) visualizes the threshold intensity used to delimit object pixels (in black rendering) from background (in light rendering). The positional components of the compressed vector dataset resultant from the analysis and about 10% of all vectors comprised in the compressed vector dataset (arrows) are visualized in (B).

FIG. 10: Example of an image analysis according to the method of the invention. The method of the invention can also be utilized for text recognition: template digital image (A) shows the digital image resulting from scanning a printout of the letters “πΨΩ”. The positional components of the compressed vector dataset resultant from the analysis and about 10% of all vectors comprised in the compressed vector dataset (arrows) are visualized in (B).

FIG. 11: Transformation of digital images comprising a mechanical part representing a more complex geometric object (top left and bottom left image). The geometry, dimension and directional (rotational) orientation is conserved in the vectors obtained when utilizing the method of the present invention (visualized in top right and bottom right image).

FIG. 12: Demonstration of an image analysis of similar objects in a digital image (A). The similarity is clearly visible from the positional components of the compressed vector dataset (B), which can be further utilized to compute by methods comprised in the art the numerical degree of similarity between the objects. In panel (C) the positional components of the compressed vector dataset and about 10% of its vectors are visualized as arrows.

FIG. 13: Example for noise tolerance. The digital image (A) comprises an object (black) and noise in the background (see right side and inset depicting an enlarged area of the digital image). The method of the invention is noise tolerant, resulting in a vector dataset shown in (B). In comparison, vector dataset (C) is obtained with another, noise-sensitive method, resulting in an inferior dataset. Approximately 10% of the vectors of the respective vector datasets are shown.

FIG. 14: Example for noise tolerance. The digital image (A) comprises an object (black) and noise in the object (see inset depicting an enlarged area of the digital image). The method of the invention is noise tolerant, resulting in a compressed vector dataset (C). In comparison, vector dataset (B) is obtained with another, noise-sensitive method. Approximately 10% of the vectors of the respective vector datasets are shown.

FIG. 15: Examples for execution times of the method of the invention. A digital image (FIG. 10A) of various sizes is transformed using a data-processing system comprising an Intel x86 Celeron CPU with a 1.1 Ghz clock frequency. The execution time is directly proportional to the digital image size. Thus, depending on the image resolution and using average computer hardware, 30 frames per second (fps) can be analyzed using the method of the invention.

FIG. 16: Examples of data (digital image) compression ratios obtainable using the method of the invention.

¹ One pixel=5 Bytes: two Bytes for x-coordinate, two Bytes for y-coordinate, one Byte for intensity value;
² One vector=6 Bytes: two Bytes for x-coordinate, two Bytes for y-coordinate, one Byte for radius, one Byte for angle;
³ % Compression=100−(Vector data/Object Data)*100;

FIG. 17: Comparison of execution times of the method of the invention when using optimized circle (CC) selection. All object pixels are transformed and the radius of the circle (CC) is selected with or without optimization (see description for details). Template image was FIG. 11 (bottom left image; 512×512 pixels).

FIG. 18: Left upper panel: digital image taken by a camera mounted on a vehicle travelling on a road; right upper panel: a threshold was used to analyze the digital image shown in the upper left panel: object-pixels are depicted in black and the background in white. Bottom panel: using a preferred embodiment of the method of the invention, the digital image was transformed into vectors using the threshold shown. Approximately 10% of all vectors that were obtained by the preferred embodiment of the method of the invention are shown for better visibility. This demonstrates that the image analysis method of the present invention is capable of effectively analyzing objects on the road (e.g. side-strips, other cars e.t.c) or next to the road (e.g. reflector posts). The size of the digital image was 800×600 pixels and the processing time was 30 ms on a personal computer equipped with a Pentium processor running at 1.4 Ghz and comprising 1 GByte of RAM.

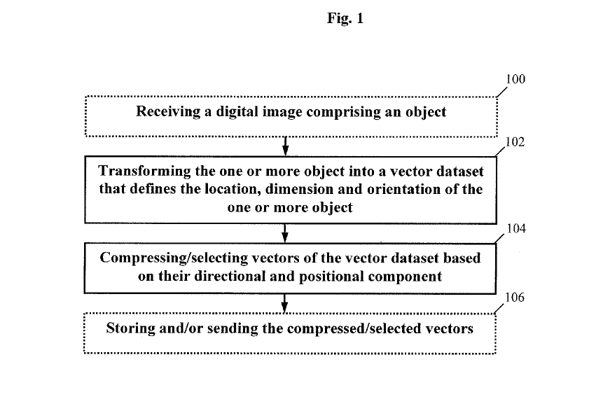

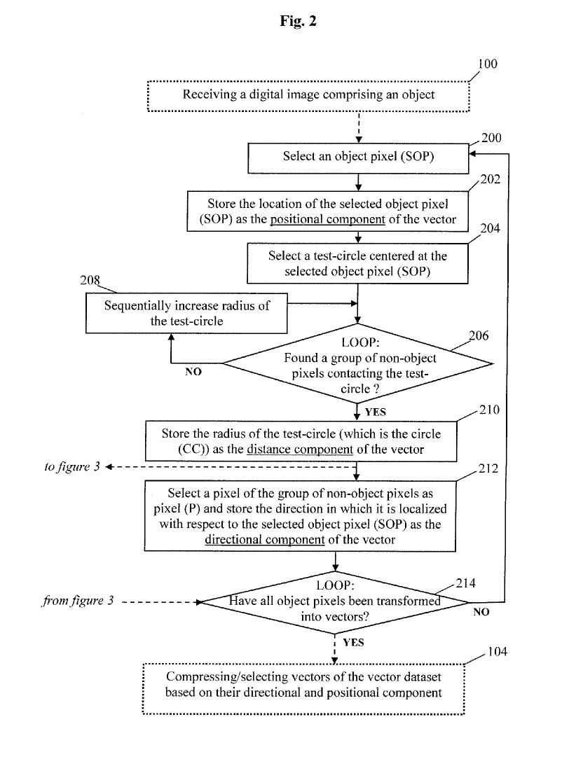

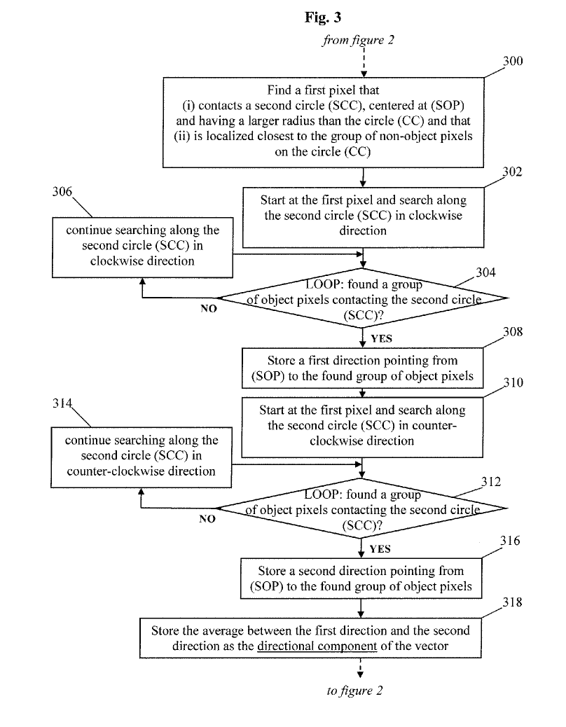

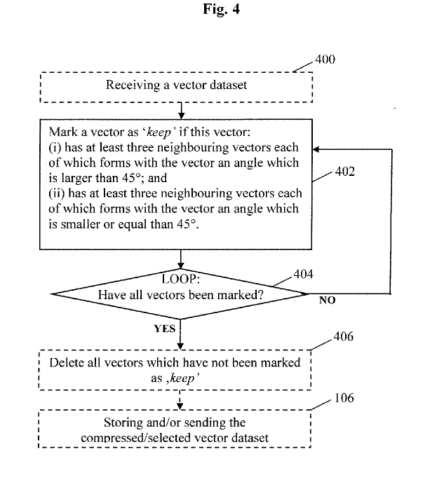

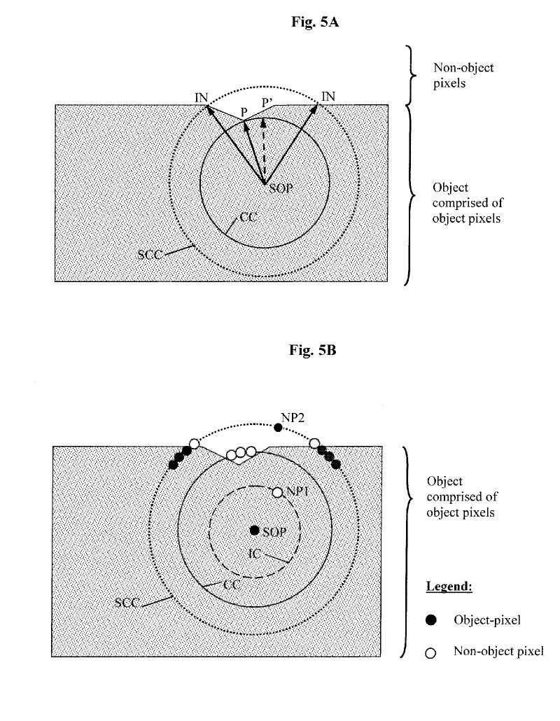

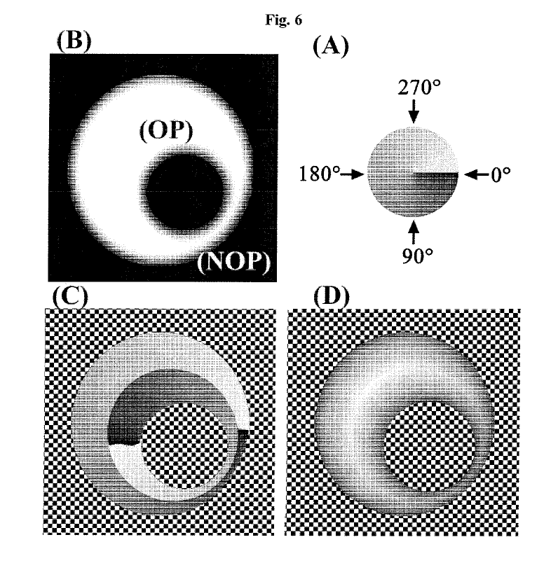

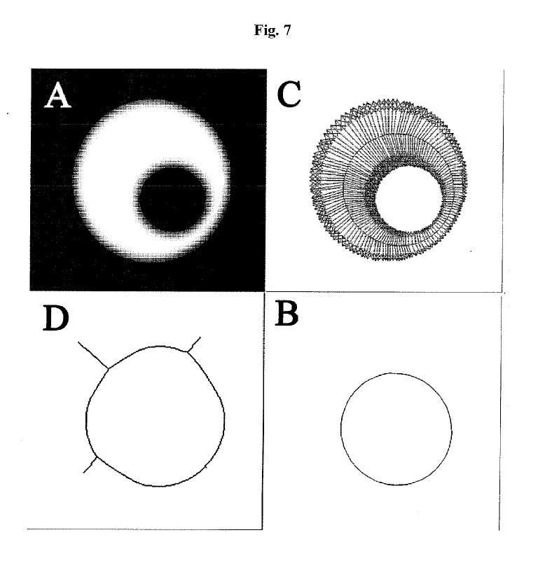

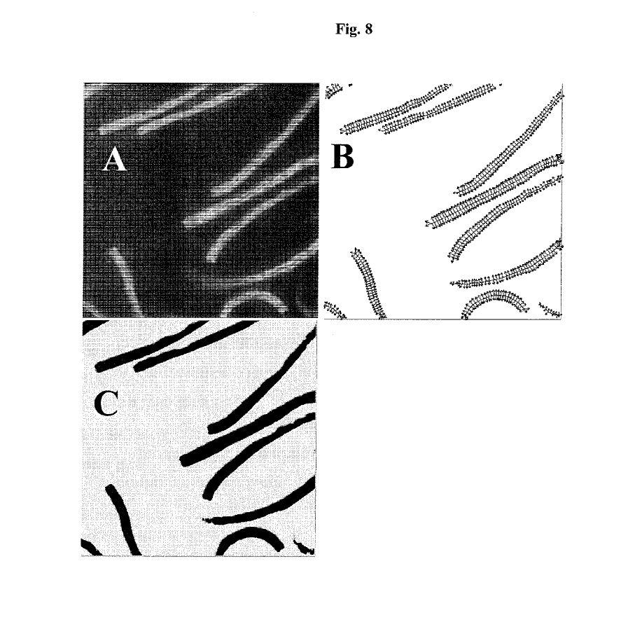

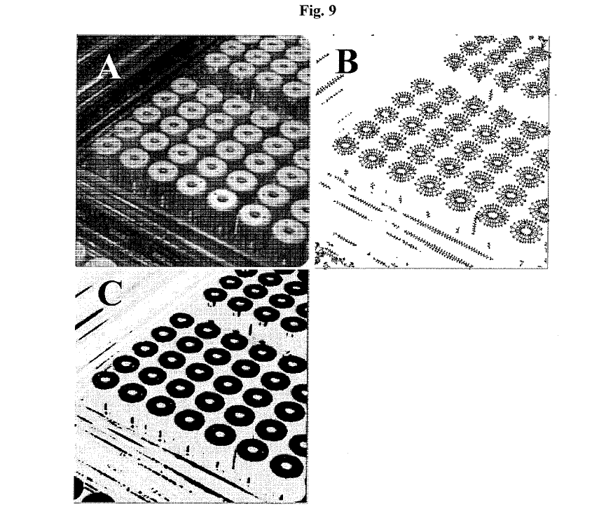

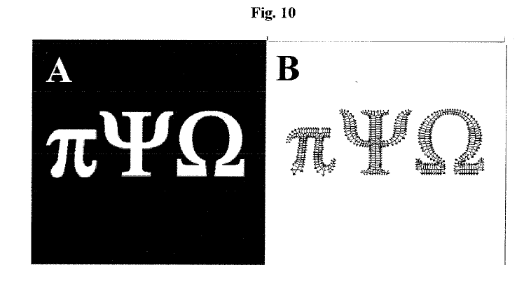

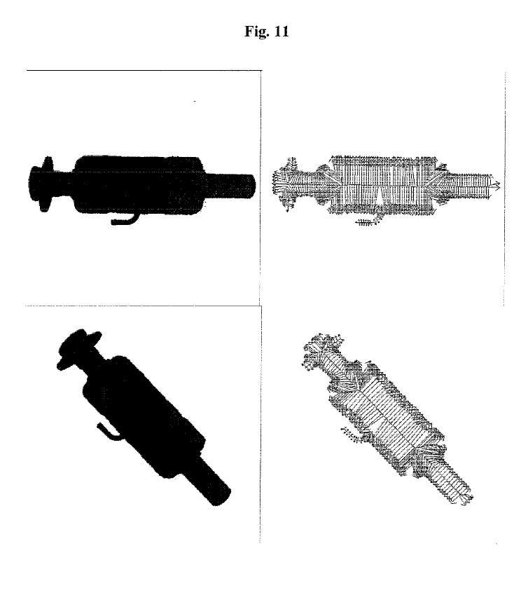

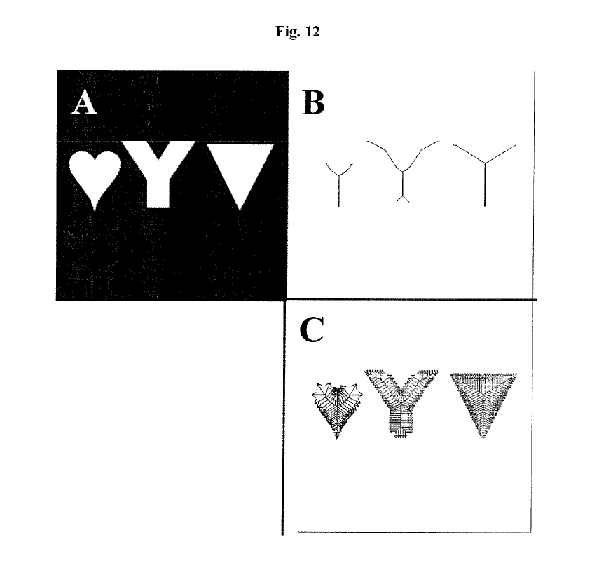

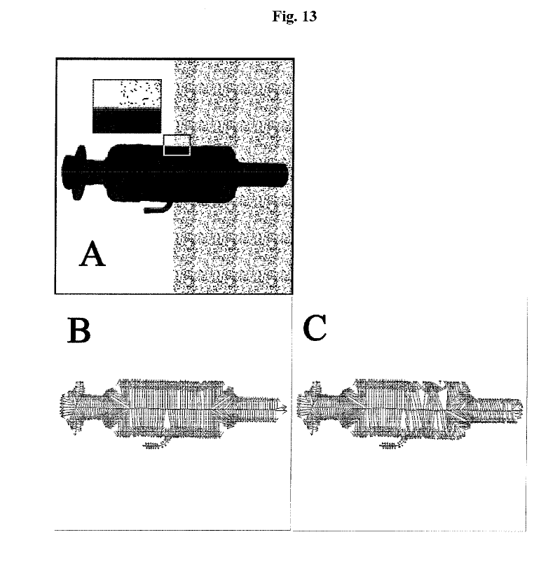

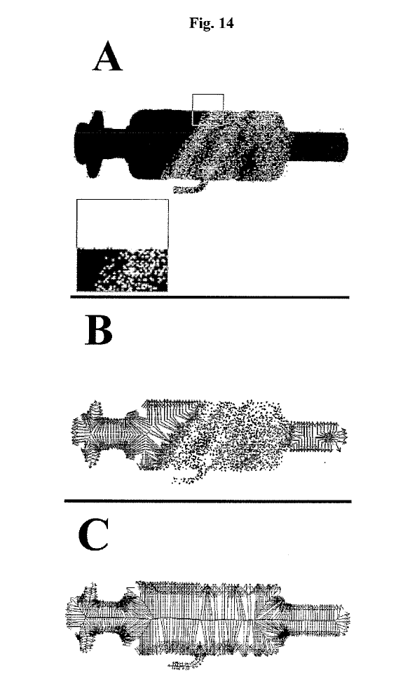

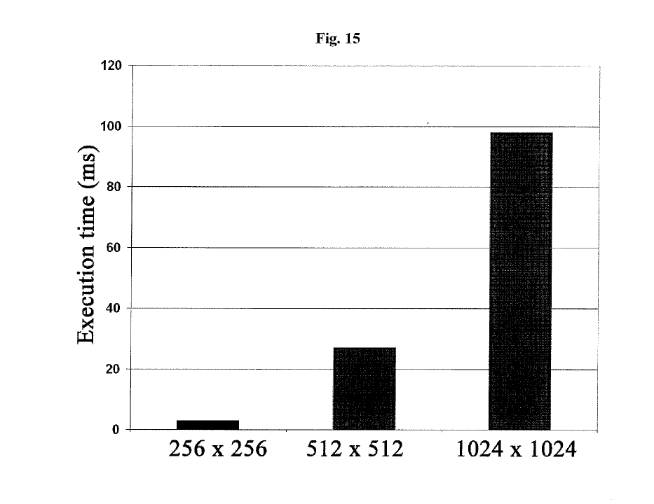

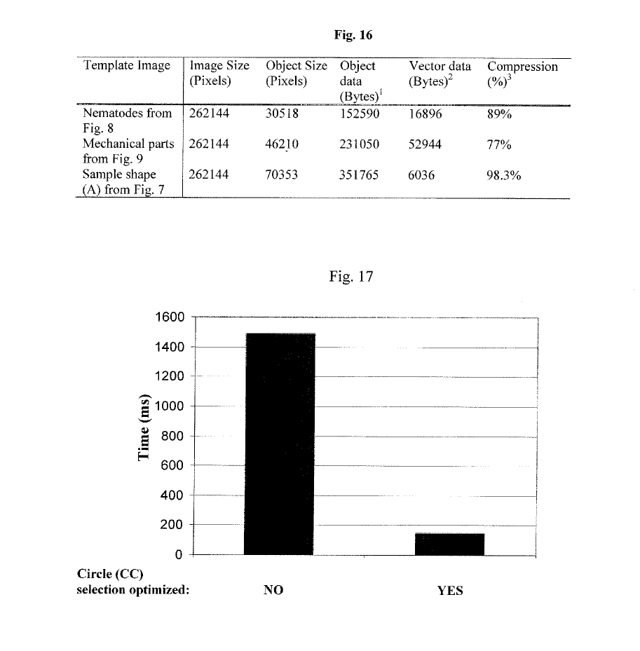

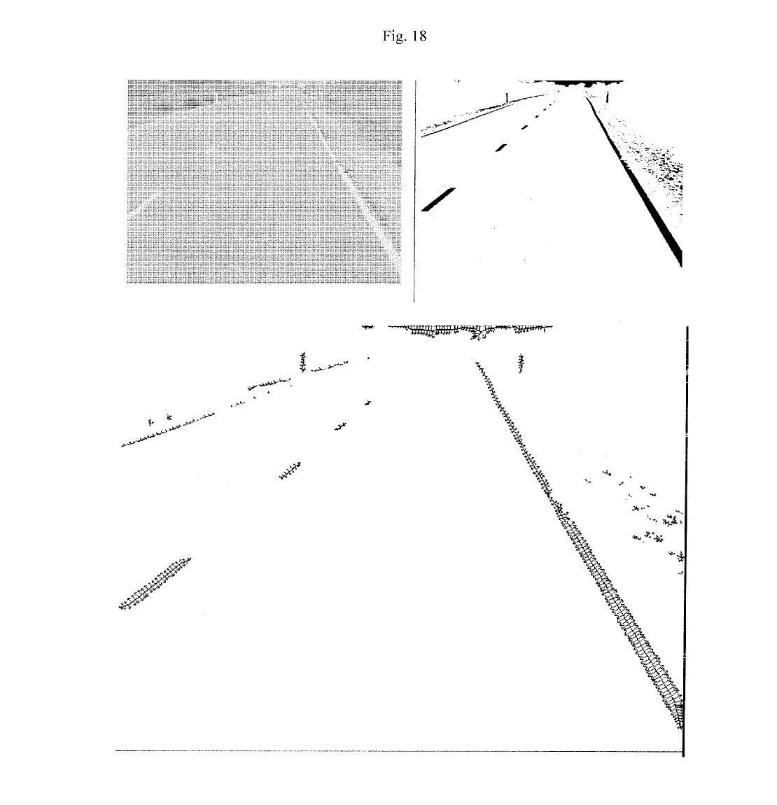

### EXAMPLES

### Example 1

The method of the invention has been implemented using the C programming language but any other programming language comprised in the art, for example JAVA, Pascal, Assembly language, Fortran and so forth can be used to implement the method of the invention. Following compilation of the source code, the executable program was installed on a computer (data processing system) comprising a memory device and an operating system and which was connected with the digital camera of a microscope. Digital images were received from the digital camera or were received from a remote database (world wide web) and were analyzed by the image analysis computer program product of the invention which carries out the method of the invention. Different sized images were analyzed comprising one or more objects and all object pixels of each digital image were transformed into a respective vector dataset. Exemplary images and corresponding vector datasets obtained are shown in the figures.

1. Image analysis method for analyzing a digital image comprising a plurality of object-pixels that define at least one object in said digital image, wherein the image analysis method comprises the step of transforming at least one object-pixel into at least one vector in a vector dataset and wherein the at least one vector comprises a positional component, a directional component and a distance component.

2. Image analysis method according to claim 1, wherein the positional component of each vector is selected such that it defines the location of the respective transformed object-pixel and the distance and directional component of each vector is selected such that the transformed vector is a surface normal vector.

3. Image analysis method according to claim 1 or 2, wherein the transforming step of the method comprises the step:
(a) selecting the positional, directional and distance component of each vector such that the vector points from the respective object-pixel to the non-object pixel or to the group of non-object pixels that is located closest to said respective object-pixel;

4. The image analysis method according to any of claims 1 to 3, wherein the transforming step of the method comprises the step:
(b) adjusting the directional components of the vectors of the vector dataset such that the vectors are surface-normal vectors.

5. The image analysis method according to any of claims 1 to 4, wherein the method further comprises the step:
(c) selecting a subset of vectors in the vector dataset based on the directional component of the vectors in the vector dataset.

6. The image analysis method according to any of claims 3 to 5, wherein in step (a) each vector is determined by carrying out at least the following steps:
(i) selecting an object pixel (SOP);
(ii) selecting a circle (CC) which
(a1) is centered at the selected object pixel (SOP); and
(b1) contacts at least one object pixel; and
(c1) contacts at least one non-object pixel or a group of non-object pixels;
(iii) selecting a pixel (P) that contacts the circle (CC) and that defines the vector which points from the selected object pixel (SOP) to the selected pixel (P); and
(iv) optionally storing and/or transmitting the vector determined in step (iii).

7. The image analysis method according to any of claims 6, wherein the group of non-object pixels comprises at least two non-object pixels and wherein within said group of non-object pixels, each non-object pixel contacts at least one other non-object pixel of said group of non-object pixels.

8. The image analysis method according to any of claim 6 or 7, wherein the pixel (P) is selected from said group of non-object pixels.

9. The image analysis method according to any of claims 6 to 8, wherein in step (ii) the circle which has the smallest radius of all circles that fulfil criteria (ii)(a1), (ii)(b1) and (ii)(c1) is selected as the circle (CC).

10. The image analysis method according to any of claims 6 to 9, wherein in step (ii) the circle (CC) is selected from a group of circles each of which has a radius which does not differ by more than 10 pixels from the distance component of a vector of a previously transformed object-pixel which either contacts the selected object pixel (SOP) or which is localized not farther than 10 pixels away from the selected object pixel (SOP).

11. The image analysis method according to any of claims 4 to 10, wherein the adjusting step (b) comprises the step of:
selecting in step (iii) of step (a) a pixel which contacts the circle (CC) and which is located equidistant to two pixels each of which is localized at an intersection between a second circle (SCC) which
(a2) is centered at the selected object pixel (SOP); and
(b2) contacts at least one object pixel; and
(c2) contacts at least one non-object pixel; and
(d2) has a radius which is larger than the radius of the circle (CC); and
(e2) which contacts not more non-object pixels than object pixels; and
the boundary of the object in said digital image that comprises the selected object pixel (SOP),
as the pixel (P).

12. The image analysis method according to claim 11, wherein the intersection between the boundary of the object and the second circle (SCC) is the location of a group of pixels, wherein:
(a3) the group of pixels comprises at least one non-object pixel and at least two object-pixels; and
(b3) all pixels of said group of pixels contact the second circle (SCC); and
(c3) each object-pixel in said group of pixels contacts at least one other object-pixel in said group of pixels.

13. The image analysis method according to claim 5-12, wherein in the selection step (c) vectors are selected if they contact each other and if they have unequal directional components.

14. The image analysis method according to claim 5-13, wherein the selection step (c) comprises selecting vectors if they contact each other and if their directional components are sufficiently dissimilar such that at least 90% of said vectors comprise a positional component that defines a pixel on the medial axis of said object.

15. The image analysis method of any of claims 5-14, wherein the selection in step (c) is carried out by removing from said vector dataset any vector that does not have at least two neighbouring vectors, each of which forms with the vector an angle which is larger than about one eighth of the maximum angle which defines one complete circle.

16. The image analysis method of any of claims 5-15, wherein the selection step (c) comprises a step of removing from said vector dataset a vector if the vector does not fulfil the following two conditions:
(1) the vector has at least three neighbouring vectors each of which forms with the vector an angle which is larger than about one eighth of the maximum angle which defines one complete circle; and
(2) the vector has at least three neighbouring vectors each of which forms with the vector an angle which is smaller or equal than about one eighth of the maximum angle which defines one complete circle.

17. The image analysis method according to any of claims 6-16, wherein step (iii) and/or step (c) comprises the step of storing
(1) the location of the selected object pixel (SOP) in the digital image as the positional component of the at least one vector;
(2) the direction in which the pixel (P) is localized with respect to the selected object pixel (SOP) as the directional component of the at least one vector; and/or
(3) the radius of the circle (CC) as the distance component of the at least one vector.

18. A computer program product stored on a computer readable storage medium comprising a computer-readable program code for causing a data processing system to carry out the image analysis method according to any of claims 1 to 17.

19. Apparatus for carrying out the image analysis method according to any of claims 1 to 17.

20. The apparatus of claim 19, wherein the apparatus comprises an electronic integrated circuit capable of carrying out the image analysis method according to any of claims 1 to 17; wherein said method is not implemented as a program but as an electronic integrated circuit.

21. The apparatus of claim 19, wherein the electronic integrated circuit is an application-specific integrated circuit (ASIC).

22. Data processing system comprising a memory device, an operating system and the computer program product according to claim 18 which is loaded into the memory device of said data processing system and wherein the data processing system is capable of carrying out the image analysis method according to any of claims 1 to 17.

23. Image analysis system comprising an imaging device and the data processing system of claim 22 or the apparatus according to any of claims 19 to 21; wherein the imaging device is capable of acquiring digital images and wherein the acquired digital images are transferred to said data processing system or said apparatus.

24. The image analysis system of claim 23, wherein the imaging device is selected from the group consisting of a digital camera, a computed tomography (CT) scanner, a magnetic resonance imaging (MRI) scanner, a positron emission tomography (PET) scanner, an ultrasonograph, an echo sonar, a night vision device, a flat-bed scanner, a database comprising one or more images, a fingerprinting device, a fax machine, a radar equipment and an X-ray imaging device.

25. The image analysis system according to claim 24, wherein the digital camera is mounted on a microscope or an endoscope.

26. The image analysis system according to claim 25, wherein the microscope is a light microscope or an electron microscope or an atomic force microscope.

27. System for controlling a vehicle travelling on a road, comprising:
(a4) a vehicle; and
(b4) an image analysis system according to claim 24, wherein the imaging device is a digital camera, a night vision device and/or a radar equipment; and
(c4) optionally a computational device which receives at least one vector dataset from the image analysis system and determines the relative position and the relative velocity of detected objects with respect to the position and velocity of the controlled vehicle; and
(d4) optionally a controlling device which receives the computed data from the computational device and controls the direction in which the vehicle is driving and the vehicle's velocity such as to prevent the vehicle form leaving the sides of the road and/or to prevent a collision with an object on the road.

28. Use of the image analysis method according to any of claims 1 to 17, the data processing system of claim 22, the apparatus according to any of claims 19 to 21, or the image analysis system according to any of claims 23 to 26 in an application selected from the group consisting of medical image analysis, traffic control, vehicle guidance, automated product quality control, semiconductor chip topography quality control, semiconductor chip connector quality control, microscopy image analysis, similarity searches for similar digital images in a database, digital image compression and text recognition.
